(19) United States
(12) Patent Application Publication
(10) Pub. No.: US 2006/0114209 A1
(43) Pub. Date: Jun. 1, 2006

(54) Gate line driving circuit, display device having the same, and apparatus and method for driving the display device

(75) Inventors: Byoung-Suk Kim, Seoul (KR); Jin-Woo Park, Yongin-si (KR); Byoung-Sun Na, Hwaseong-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/285,858

(22) Filed: Nov. 23, 2005

(30) Foreign Application Priority Data
Nov. 26, 2004 (KR) 10-2004-98065

(51) Int. Cl. G09G 3/36

(52) U.S. Cl. 345/94

(57) ABSTRACT

In a gate line driving circuit, a display device, a driving apparatus and a driving method, a shift register sequentially shifts and outputs a high level data in response to a carry signal. A level shifter level-shifts an externally provided first voltage based on the high level data. An output buffer buffers the level-shifted first voltage and outputs the buffered level-shifted first voltage to a delay. The delay delays the buffered level-shifted first voltage and outputs the delayed level-shifted first voltage to a gate line. Thus, the delay applied to output stages of the gate line driving circuit act to delay the gate signal, thereby preventing deterioration of display quality caused by a kickback voltage.

### CROSS-REFERENCE TO RELATED APPLICATION

This application relies for priority upon Korean Patent Application No. 2004-98065 filed on Nov. 26, 2004, the contents of which are herein incorporated by reference in their entirety.

### BACKGROUND OF THE INVENTION

1. Field of the Invention

The present invention relates to liquid crystal displays (LCDs). More particularly, the present invention relates to a gate line driving circuit with impedance at an output stage of the driving circuit, an LCD device having the driving circuit, a driving apparatus for the display device and a driving method for the display device.

2. Description of the Related Art

An LCD device applies an adjustable electric field to a liquid crystal material having an anisotropic dielectric constant. This liquid crystal material is inserted between two substrate layers, thereby adjusting the amount of light penetrating through the liquid crystal material and displaying a desired image. In the LCD device, the data signal that applies the adjustable electric field is controlled by a gate signal voltage applied to a gate terminal. The adjustable data signal voltage gradually changes a polarization state of the liquid crystal material, so that the LCD device displays various gray levels.

To accomplish this, the LCD device typically includes a source driver integrated circuit (IC) and a source printed circuit board (PCB) driving the source driver IC, a gate driver IC and a gate PCB driving the gate driver IC.

Recently, in order to reduce manufacturing cost and simplify manufacturing processes, numbers of output channels of the source driver IC and the gate driver IC have increased. For example, source driver ICs used in SXGA 642×342 resolution LCD panels have adopted 642 output channels instead of 384 output channels, reducing the number of ICs from ten units to six. Similarly, the gate driver ICs have adopted 342 output channels instead of 256 output channels, reducing the number of these ICs from four units to three.

However, when these multi-channel ICs are used in an LCD panel, they are connected to fan-outs of variable length. The varying lengths of these fan-outs produces kickback voltages of varying magnitude, which deteriorate display characteristics of the LCD device.

Further, as a size of the LCD panel becomes large, the kickback voltages, owing to increase of a resistance-capacitance delay (RC delay) of a gate voltage, also increase, thereby increasing distortion.

### SUMMARY OF THE INVENTION

The invention can be implemented in numerous ways, including as a method and an apparatus. Various embodiments of the invention are discussed below.

In one aspect of the present invention, a gate line driving circuit outputting a gate signal to multiple gate lines formed on a display panel includes a shifter register, a level shifter, an output buffer and a delay.

The shift register sequentially shifts a high level data by one line time interval in response to a carry signal and outputs the shifted high level data. The level shifter level-shifts an externally provided first voltage based on the high level data from the shift register and outputs the level-shifted first voltage. The output buffer buffers the level-shifted first voltage from the level shifter and outputs the buffered first voltage. The delay forcedly delays the buffered first voltage from the output buffer by a predetermined time and outputs the delayed first voltage to the gate lines.

In another aspect of the present invention, a display device includes a display panel, a data driver part and a gate driver part.

The display panel includes multiple gate lines, multiple data lines, multiple switching elements formed in regions surrounded by neighboring gate lines and neighboring data lines and electrically connected to the gate lines and the data lines, and multiple pixels electrically connected to the multiple switching elements, respectively. The data driver part is configured to output a data signal to the data lines, and the gate driver part is configured to forcedly delay a gate signal and output the forcedly-delayed gate signal to the gate lines.

In another aspect of the present invention, a display device includes a display panel, a data driver part, a gate driver part and multiple fan-outs.

The display panel includes multiple gate lines, multiple data lines, multiple switching elements formed in regions surrounded by neighboring gate lines and neighboring data lines and electrically connected to the gate lines and the data lines, and multiple pixels electrically connected to the multiple switching elements, respectively. The data driver part is configured to output a data signal to the data lines, and the gate driver part is configured to forcedly delay a gate signal and output the forcedly-delayed gate signal to the gate lines. The multiple fan-outs electrically connect output stages of the gate driver part and the gate lines and have a substantially same length.

In another aspect of the present invention, a driving apparatus includes a display device. The display device includes a display panel, a data driver part and a gate driver part.

The display panel includes multiple gate lines, multiple data lines, multiple switching elements coupled to the gate lines and the data lines, and multiple pixels coupled to the multiple switching elements, respectively. The data driver part is configured to output a data signal to the data lines, and the gate driver part configured to forcedly delay a gate signal and output the forcedly-delayed gate signal to the gate lines.

In another aspect of the present invention, a driving method to drive a display panel including multiple gate lines, multiple data lines, multiple switching elements formed in regions surrounded by neighboring gate lines and neighboring data lines and connected to the gate lines and the data lines, and multiple liquid crystal capacitors electrically connected to the multiple switching elements is provided as follows. A data signal is provided to the multiple data lines, and a forcedly-delayed gate signal is provided to the multiple gate lines in response to an externally provided carry signal in order to charge the data signal into the liquid crystal capacitors.

### BRIEF DESCRIPTION OF THE DRAWINGS

The above and other advantages of the present invention will become readily apparent by reference to the following detailed description when considered in conjunction with the accompanying drawings wherein:

FIG. 1 is a circuit diagram illustrating a unit cell of an LCD;

FIG. 2 is a waveform diagram illustrating a gate voltage and data voltage applied to the unit cell of the LCD;

FIG. 3 is a waveform diagram illustrating a gate voltage and an actual data voltage observed at the unit cell of the LCD;

FIG. 4 is a plot illustrating a display characteristic degradation caused by kickback voltage in FIG. 3;

FIG. 5 is a waveform diagram illustrating gate voltage applied successively to row directional gate line;

FIG. 6 is a block diagram illustrating a LCD device according to embodiments of the invention;

FIG. 7 is a block diagram illustrating a gate line driving circuit in FIG. 6;

FIG. 8 is a waveform diagram illustrating gate voltage outputted from the gate line driving circuit in FIG. 7;

FIG. 9 is a waveform diagram illustrating the gate voltage and a data voltage applied to a unit cell of the LCD in FIG. 6;

FIG. 10 is a waveform diagram illustrating the actual data voltage applied to the liquid crystal layer when applying the gate voltage in FIG. 9;

FIG. 11 is a plot illustrating an LCD device having improved kickback voltage characteristic according to embodiments of the invention;

FIG. 12 is a waveform diagram illustrating gate voltage applied to any gate line in FIG. 11;

FIG. 13 is a block diagram an LCD device according to embodiments of the invention;

FIG. 14 is a plot illustrating fan-outs that connect the gate line driving circuit with gate lines in FIG. 13; and

FIG. 15 is a waveform diagram illustrating kickback voltage observed in a cell of a conventional device and kickback voltages of embodiments, all cases with same column direction.

### DETAILED DESCRIPTION OF EMBODIMENTS OF THE INVENTION

Hereinafter, embodiments of the present invention will be explained in detail with reference to the accompanying drawings.

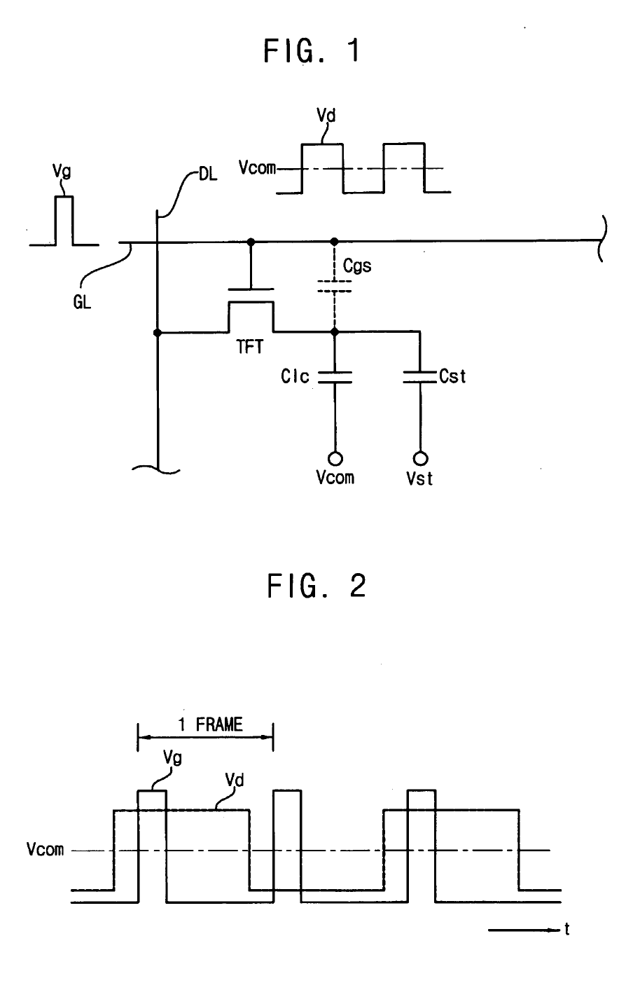

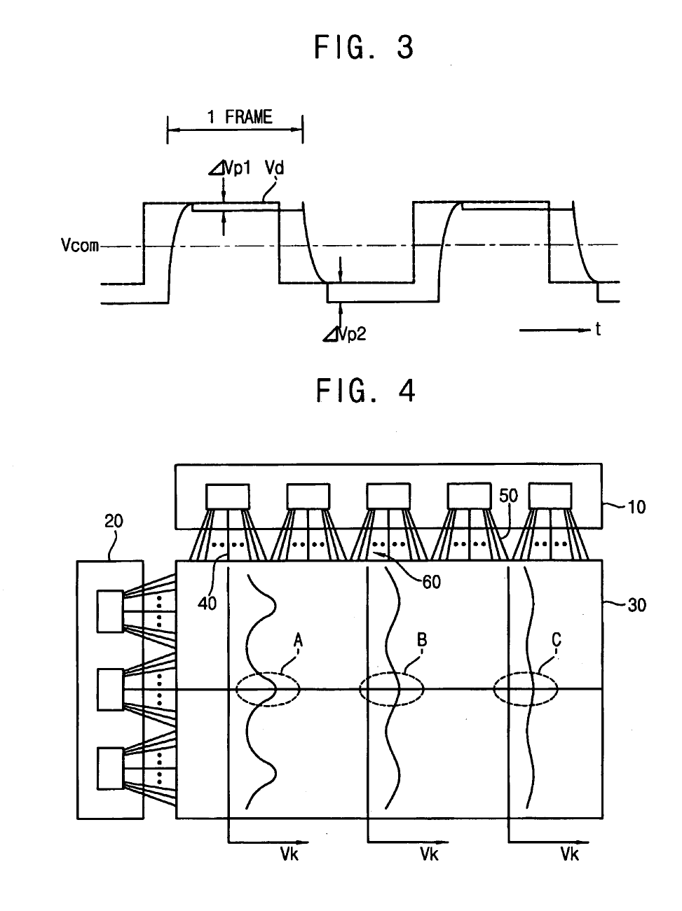

FIG. 1 is a circuit diagram illustrating a unit cell of an LCD. FIG. 2 is a waveform diagram illustrating a gate voltage and data voltage applied to the unit cell. FIG. 3 is a waveform diagram illustrating a gate voltage and an actual data voltage of the unit cell.

Referring to FIGS. 1 and 2, a data voltage Vd has a positive constant level in comparison with a common terminal voltage Vcom during the n-th frame duration, and a negative constant level in comparison with the common terminal voltage Vcom during the (n+1)-th frame duration. During the (n+2)-th frame duration, the data voltage Vd again has a positive constant level in comparison with the common terminal voltage Vcom.

A gate voltage Vg is applied to a gate line GL in order to turn on/off a switching element thin film transistor (TFT) formed on the LCD panel.

Due to distortion and other effects, the actual data voltage waveform Vd often looks as shown in FIG. 3. Notably, its positive and negative levels are shifted slightly. More specifically, during the n-th frame duration while the gate voltage Vg is applied to the switching element TFT, the voltage shift at the unit cell is referred to as a first kickback voltage ΔVp1. ΔVp1 represents a voltage difference between the data voltage Vd that is provided through the data line DL and a voltage that is actually applied to the liquid crystal layer.

During the (n+1)-th frame duration while the gate voltage Vg is applied to the switching element TFT, the voltage shift at the unit cell is referred to as a second kickback voltage ΔVp2, which has a greater magnitude than that of the first kickback voltage ΔVp1. ΔVp2 represents a voltage difference between the data voltage Vd that is provided through the data line DL and a voltage that is actually applied to the liquid crystal layer. As mentioned, the second kickback voltage ΔVp2 is larger than the first kickback voltage ΔVp1.

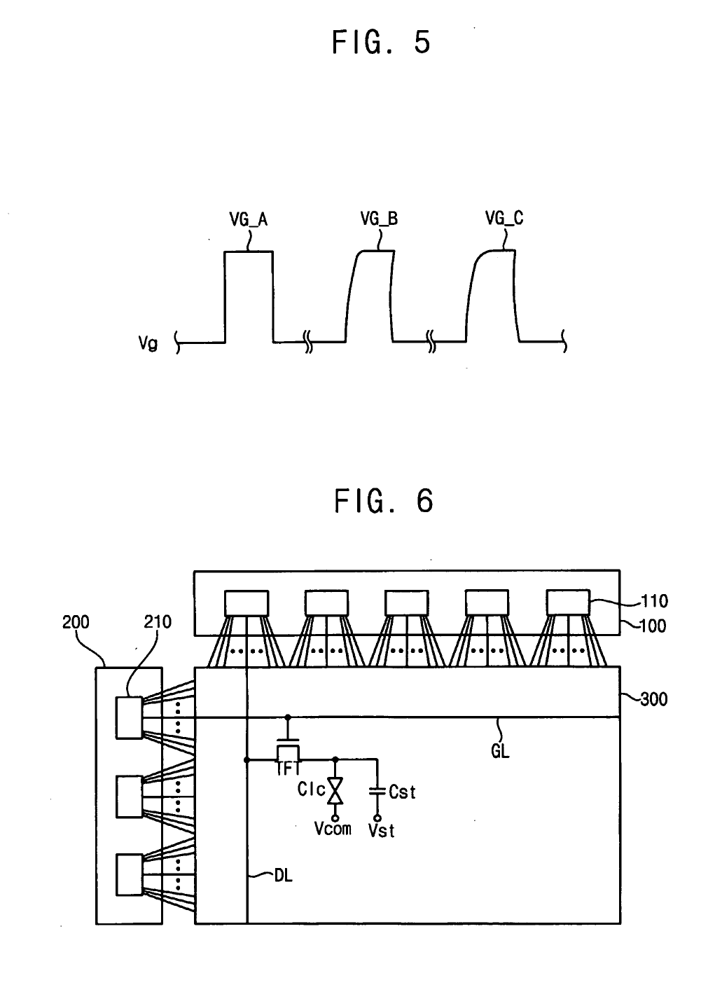

FIG. 4 is a plan view illustrating image defects caused by the kickback voltages shown in FIG. 3. As can be seen, image distortion is generated by kickback voltages whose magnitudes vary with the length of their associated fan-outs. FIG. 5 is a waveform diagram illustrating a gate voltage sequentially applied to a row directional gate line.

Referring to FIGS. 4 and 5, when the gate line driving circuit generates the gate voltage for each gate line, the kickback voltages corresponding to column directional gate lines and the row directional gate lines, respectively, generate considerable image distortion.

For ease of illustration, the various kickback voltages ΔVp1, ΔVp2 are also referred to collectively as simply Vk. In the far-left portion of an LCD panel 30 adjacent to gate driver 20, a kickback voltage Vk is relatively high at unit cells where the fan-outs 40 of the gate drivers are relatively short. Conversely, the kickback voltage Vk is relatively low at the unit cells where the fan-outs 50 of the gate drivers are relatively long. Intermediate-length fan-outs 60 generate kickback voltages Vk whose magnitudes are between those generated at short fan-outs 40 and long fan-outs 50. In summary, among the same column directional unit cells of the LCD panel 30, the magnitude of kickback voltages varies in accordance with the fan-out length of the unit cell.

Additionally, among the row directional unit cells of the LCD panel 30, the kickback voltage Vk corresponding to the left column part is highest, and the kickback voltage Vk corresponding to the right column part is lowest. Therefore, the kickback voltages of the unit cells vary widely along rows of the LCD panel 30.

In summary, kickback voltages vary widely along columns of the LCD panel 30, in accordance with the length of the fan-outs. Similarly, kickback voltages also vary widely along rows of the LCD panel 30. It follows that Root-Mean-Square (RMS) voltages of the unit cells of the LCD panel 30 vary according to position on the LCD panel 30.

### Embodiment 1

FIG. 6 is a block diagram illustrating a liquid crystal display device according to an exemplary embodiment of the present invention.

Referring to FIG. 6, an LCD device according to the exemplary embodiment of the present invention includes a source driver part 100, a gate driver part 200 and an LCD panel 300.

The source driver part 100 includes multiple source driver chips 110, and provides multiple data voltages to the LCD panel 300. The source driver chips 110 may be directly integrated neighboring a peripheral area of the LCD panel 300, or mounted on an additional flexible printed circuit board (FPCB).

The gate driver part 200 includes multiple gate line driving circuits (or gate driver chips) 210 and sequentially provides the LCD panel 300 with multiple forcedly delayed gate voltages. The gate driver chips 210 may be directly integrated neighboring the peripheral area of the LCD panel 300, or mounted on an additional FPCB.

The LCD panel 300 includes multiple gate lines GL, multiple data lines DL, and multiple switching elements TFT. Each of the switching elements TFT is formed in a region surrounded by neighboring gate lines and neighboring data lines, multiple liquid crystal capacitors Clc electrically coupled to the switching element TFT, and multiple storage capacitors Cst electrically coupled to the switching element TFT.

The switching element TFT receives the forcedly delayed gate voltage through the gate line GL and the data voltage through the data line DL. Power to the liquid crystal capacitor Clc is turned on or off according to the forcedly delayed gate voltage, in order to charge the data voltage. The storage capacitor Cst stores the data voltage applied through the switching element TFT while the switching element TFT is turned on, and provides the liquid crystal capacitor Clc with the charged data voltage while the switching element TFT is turned off.

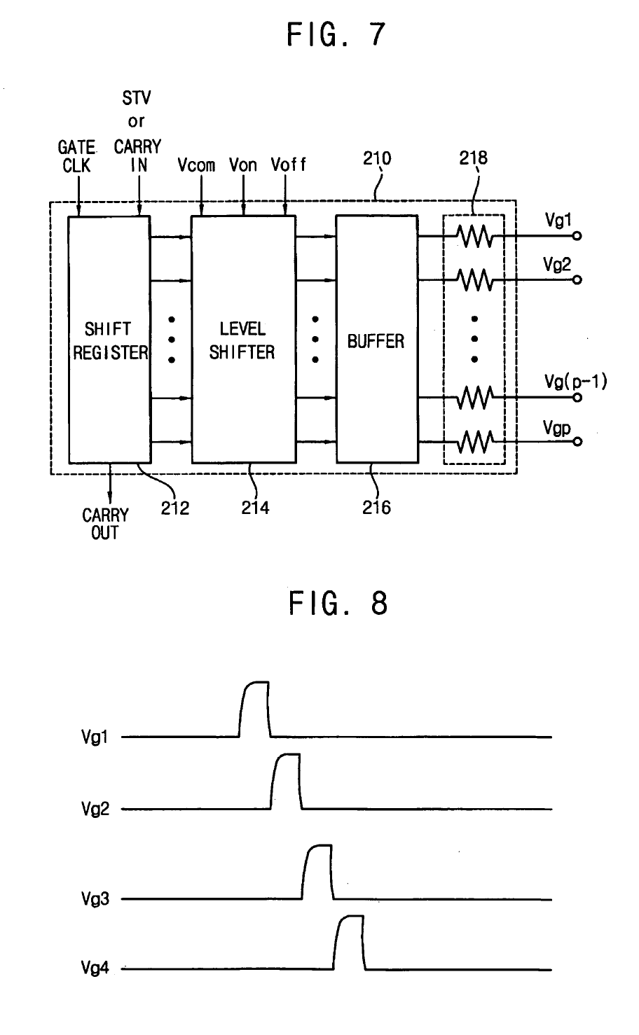

FIG. 7 is a block diagram illustrating further details of a gate line driving circuit 210. FIG. 8 is a waveform diagram illustrating an exemplary gate voltage output from the gate line driving circuit of FIG. 7.

Referring to FIGS. 6 and 8, a gate line driving circuit (or a gate driver chip) 210 includes a shift register 212, a level shifter 214, an output buffer 216, and a delay part 218 and sequentially provides the multiple gate lines GL with the forcedly delayed voltages.

The shift register 212 shifts sequentially a high level data in response to a gate clock signal (GATE CLK) and one of a vertical start signal STV and a carry-in signal (CARRY IN) at regular one-line intervals, to thereby output sequentially the shifted data to the level shifter 214 and a carry-out signal (CARRY OUT) to the next shift register. The carry-in signal (CARRY IN) is a signal that is outputted from a previous shift register to activate an operation of the shift register 212. The carry-out signal (CARRY OUT) is a signal that is outputted from the shift register 212 to activate an operation of a following shift register. In details, when the gate driver chip 210 is electrically coupled to the gate lines including a first gate line, the shift register 212 operates based on the vertical start signal STV and the gate clock signal (GATE CLK), both of the signals being provided externally. When the gate driver chip 210 is electrically coupled to the gate lines GL including other gate lines GL, the shift register 212 operates based on the carry-out signal (CARRY OUT) provided from a previous gate driver chip, which acts as the CARRY IN for the current shift register 212, and the gate clock signal (GATE CLK).

The level shifter 214 shifts the level of an externally supplied gate-on voltage Von based on from the output of the shift register 212. The level shifter 214 then outputs the level-shifted gate-on voltage Von to the output buffer 216, in order to turn on the switching element TFT.

The output buffer 216 buffers the level-shifted gate-on voltage Von, and outputs the level-shifted gate-on voltage Von to the delay 218.

The delay 218 delays the buffered gate-on voltage Von forcedly, and outputs signals to the gate lines GL in succession. More specifically, rising and falling times of the gate-on voltage Von are prolonged, but the duration of the gate-on voltage is not changed. In such an embodiment, it is possible to time the voltages Von so that successive pulses overlap, as shown in FIG. 8.

The delay 218 includes multiple impedance elements as many as the gate lines GL. In the present embodiment, the impedance elements include resistors. Each of the resistors may have equal impedance or different impedance from each other.

In this embodiment, each of the resistors has a different impedance, namely the resistors in the middle part of the gate lines have a relatively large impedance and the resistors in the outer part of the gate lines have a relatively small impedance.

When each of the resistors has the same impedance, the impedance of each resistor can typically range from about twenty percent to about thirty percent of the impedance of each coupled gate line. In the present embodiment, the delay 218 has an impedance of about 2 kg.

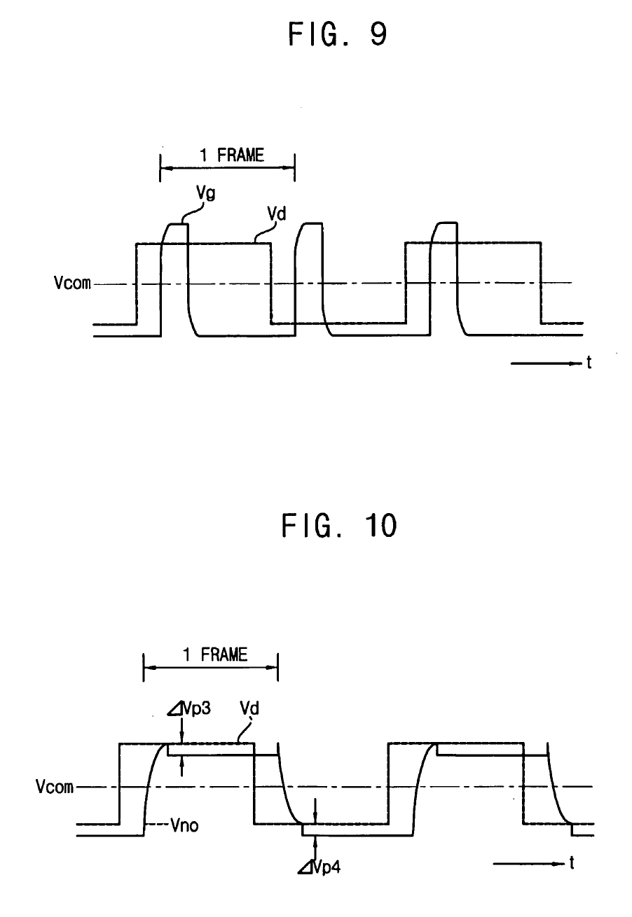

FIG. 9 is a waveform diagram illustrating a gate voltage and a data voltage applied to a unit cell of the LCD 300 of FIG. 6.

Referring to FIGS. 6 and 9, the data voltage Vd has a positive constant level in comparison with the common terminal voltage Vcom during n-th frame duration, and a negative constant level in comparison with the common terminal voltage Vcom during (n+1)th frame duration. During (n+2)-th frame duration, the data voltage Vd again has a positive constant level in comparison with the common terminal voltage Vcom.

The gate voltage Vg may be activated and applied during one “line duration” that is defined by one frame duration and numbers of the multiple gate lines GL formed on the LCD panel 300. For example, when the LCD panel has a resolution of 642×342 and the one frame duration of about 16.7 ms (or 1/60 sec), the gate voltage Vg is activated for about 48.8 ns (or 16.7 ms/342).

FIG. 10 is a waveform diagram illustrating the actual data voltage applied to the liquid crystal layer when the gate voltage of FIG. 9 is applied. Similar to FIG. 3, the delay 218 generates a Vg signal that has a relatively small kickback voltage ΔVp3, which can be referred to as a third kickback voltage. As with ΔVp1, ΔVp3 represents

a voltage difference between the data voltage Vd, which is provided through the data line DL, and the voltage that is a actually applied to the liquid crystal layer.

as the delay 218 also generates a relatively small fourth kickback voltage ΔVp4 which, like ΔVp2, is also a voltage difference between the data voltage Vd, which is provided through the data line DL, and the voltage that is a actually applied to the liquid crystal layer.

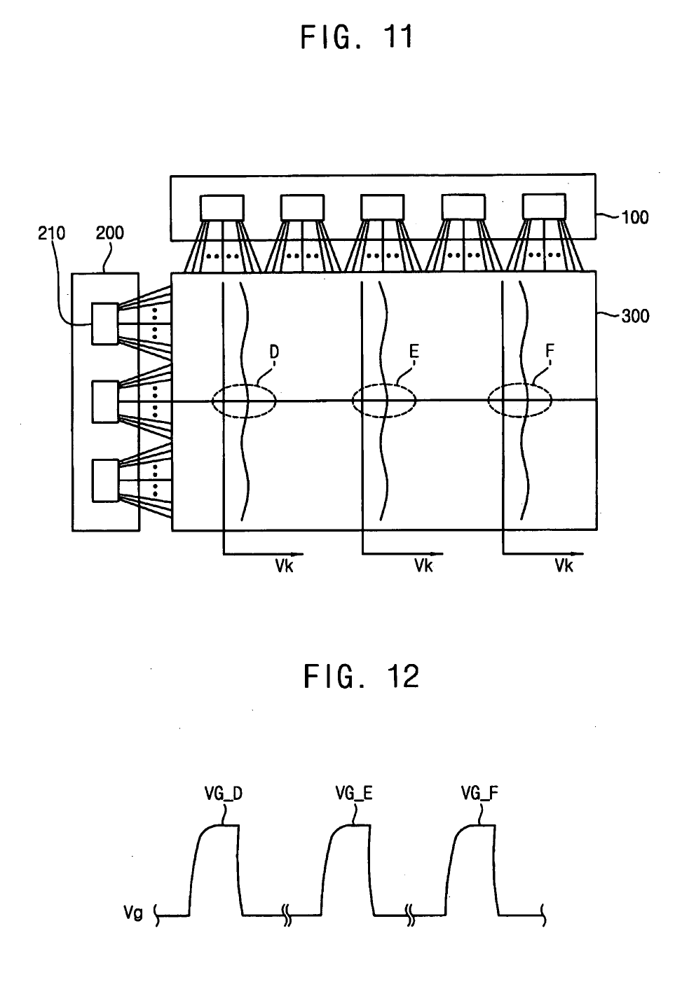

FIG. 11 is a plan view illustrating an LCD device having improved kickback voltage characteristics according to an exemplary embodiment of the invention. FIG. 12 is a waveform diagram illustrating a gate voltage randomly applied to a gate line in FIG. 11.

Referring to FIGS. 11 and 12, since the gate driver chip 210 outputs the forcedly delayed gate voltage for each gate line, the kickback voltages Vk corresponding to the column directional gate lines or row directional gate lines generate a relatively small amount of distortion in comparison with the LCD device shown in FIG. 4.

Additionally, in the far-left column of the LCD panel 300 adjacent to the gate driver part 200, the kickback voltages Vk of relatively short fan-outs and the kickback voltages Vk of relatively long fan-outs of the gate driver chips 210 are substantially equal to each other.

Therefore, although the lengths of the fan-outs are different from each other in the same row direction of the LCD panel 300, the kickback voltages Vk of unit cells have a relatively steady magnitude deviation.

The unit cells along the same row of the LCD panel 300 have relatively uniform kickback voltages in left part and in right part, and variation in the kickback voltages Vk is small. Thus, the RMS voltages of the LCD panel 300 may be uniformly distributed, and the luminance of neighboring columns is also more evenly maintained since the positional differences of column directional kickback voltages on the LCD panel 300 are reduced.

Additionally, the RMS voltages along the row direction of the LCD panel 300 also may be uniformly distributed, and luminance of neighboring rows may be evenly maintained, since the positional differences of row directional kickback voltages on the LCD panel 300 are reduced.

### Embodiment 2

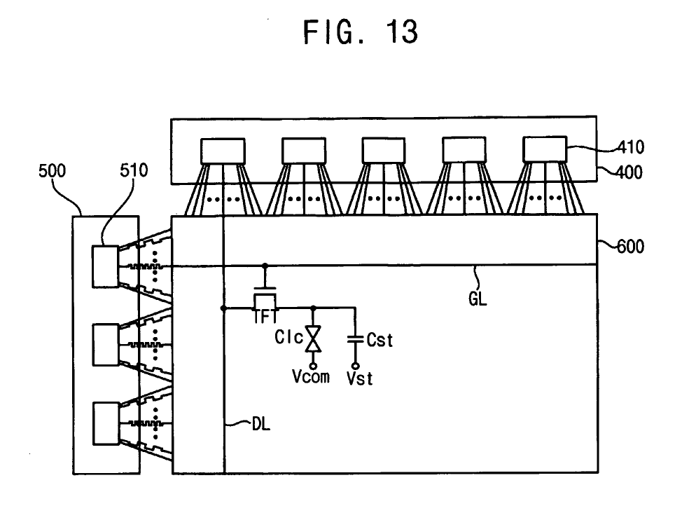

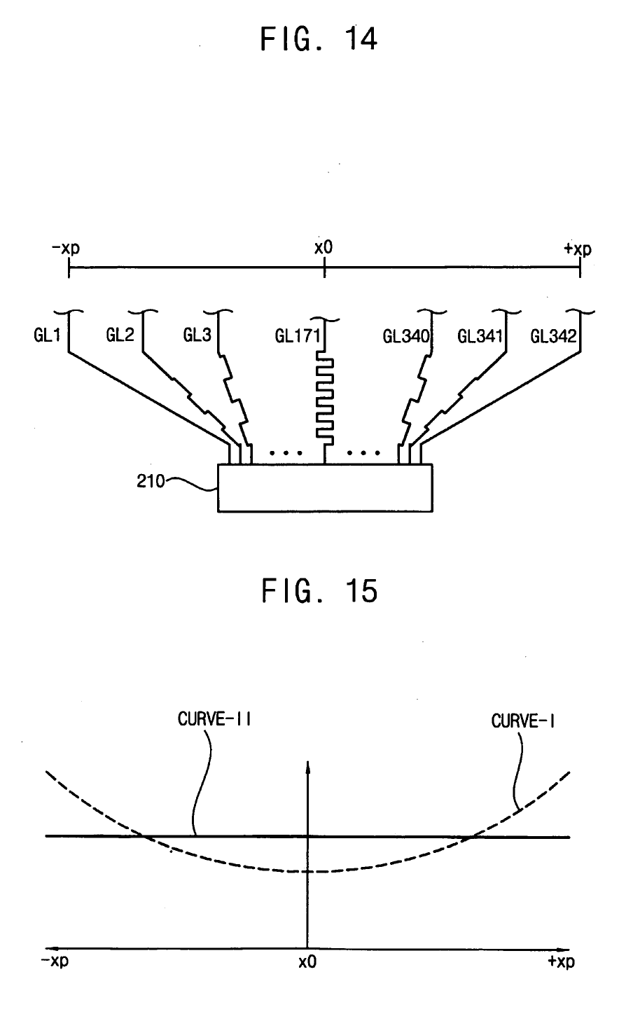

FIG. 13 is a block diagram illustrating an LCD device according to an exemplary embodiment of the invention. FIG. 14 is a plan view illustrating fan-outs that connect the gate line driving circuit with the gate lines in FIG. 13.

Referring to FIGS. 13 and 14, an LCD device according to an exemplary embodiment of the present invention includes a source driver part 400, a gate driver part 500, and an LCD panel 600.

The source driver part 400 includes multiple source driver chips 410 and provides the LCD panel 600 with multiple data voltages.

The gate driver part 500 includes multiple gate driver chips 510 and provides the LCD panel 600 with multiple gate voltages in succession. Paths of the fan-outs that couple output stages of the gate driver chips with corresponding gate lines are uniformly formed in length.

In details, the fan-outs in middle part of the gate driver chip 510 have the same length as that of either the first fan-out or the last fan-out coupled to the gate driver chip 510. Accordingly, the first fan- and the last fan-out are generally straight, while the fan-outs between may have various shapes such as a curved line, a saw-toothed line, a rectangular swing line, etc.

In the present embodiment, the fan-outs are formed in the peripheral area of an array substrate of the LCD panel 600 when the gate lines GL are formed on the array substrate. Alternatively, the fan-outs may be formed on an additional FPCB. Multiple conductive lines are formed on the FPCB, and the gate driver chip 510 is mounted on the FPCB. The FPCB electrically connects the gate lines GL and the gate driver chips 510.

The LCD panel 600 includes multiple gate lines GL, multiple data lines DL, multiple switching elements TFT, each of which is formed within a region surrounded by neighboring gate lines GL and neighboring data lines DL, multiple liquid crystal capacitors Clc electrically coupled to the switching elements TFT, and multiple storage capacitors Cst electrically coupled to the switching elements TFT.

The switching element TFT receives the delayed gate voltage through the gate line GL, and the data voltage through the data line DL. The liquid crystal capacitor Clc is turned on or turned off by the delayed gate voltage, so as to charge the data voltage Vd. The storage capacitor Cst stores the data voltage Vd applied through the switching element TFT while the switching element is turned on, and provides the liquid crystal capacitor Clc with the charged data voltage Vd while the switching element is turned off. According to this embodiment of the present invention, in order to reduce deviation of the kickback voltages, multiple impedance elements having a few kiloohms impedance are formed at respective output stages of the gate driver chip, so that the forced-delayed gate voltages are outputted from the gate driver chips and applied to the respective gate lines.

Additionally, according to another exemplary embodiment of the present invention, in order to reduce deviation of the kickback voltages, paths of the fan-outs coupling the output stages of the gate driver chip with the corresponding gate lines are formed substantially equal in length, so as to compensate for impedance of the respective fan-outs and thereby improve display characteristics.

The exemplary embodiments of the present invention may be independently applied to various LCD devices, and simultaneously applied to one LCD device. For example, the fan-outs can be formed in the peripheral area adjacent to the array substrate or on the FPCB. However, since a size of the peripheral area or the FPCB is restricted, it is preferable to apply both of the exemplary embodiments to one LCD device. FIG. 15 is a waveform diagram illustrating a kickback voltage observed in cells along the same column direction of a conventional device and kickback voltages of exemplary embodiments of the present invention.

In FIG. 15, a first kickback voltage curve CURVE-I indicates the kickback voltages corresponding to the gate voltages of a conventional device, and a second kickback voltage curve CURVE-II indicates the kickback voltages corresponding to the gate voltages of embodiments of the present invention, including one case employing delayed gate voltages, and another case employing fan-outs having the same length.

Referring to FIG. 15, when the gate voltage is applied without any compensation, the kickback voltage is maximum at the cells corresponding to the fan-outs with a shortest path. On the contrary, the kickback voltage is minimum at the cells corresponding to the fan-outs with a longest path.

With compensations, such as delaying the gate voltages or forming the fan-outs with the same length, the kickback voltages observed along the same column are substantially constant. As described above, the gate line driving circuit may reduce the kickback voltages and minimize deviation in luminance, since the gate voltages are applied at substantially same time to the respective gate lines corresponding to the same data line.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A gate line driving circuit outputting a gate signal to multiple gate lines formed on a display panel, comprising:
a shift register to sequentially shift a high level data by a time interval in response to a carry signal, and to output the shifted high level data;
a level shifter to level-shift an externally provided first voltage based on the high level data from the shift register, and output the level-shifted first voltage;
an output buffer to buffer the level-shifted first voltage from the level shifter and output the buffered first voltage; and
a delay circuit to delay the buffered first voltage from the output buffer by a predetermined time and output the delayed first voltage to the gate lines.

2. The gate line driving circuit of claim 1, wherein the time interval is defined according to numbers of the gate lines and one frame duration.

3. The gate line driving circuit of claim 1, wherein the delay circuit comprises an impedance element.

4. The gate line driving circuit of claim 1, wherein the delay circuit has an impedance in a range from about twenty percent to about thirty percent of an impedance of one of the gate lines electrically coupled to the delay circuit.

5. The gate line driving circuit of claim 1, wherein the delay circuit comprises a resistance element having a resistance of about two kiloohms.

6. The gate line driving circuit of claim 1, wherein the level-shifted first voltage has a voltage level higher than the first voltage.

7. The gate line driving circuit of claim 1, wherein the first voltage is about 3.3 Volts and the buffered first voltage is in a range from about twenty Volts to about forty Volts.

8. A display device comprising:
a display panel having:
multiple gate lines;
multiple data lines;
multiple switching elements formed in regions surrounded by neighboring ones of the gate lines and neighboring ones of the data lines, the switching elements being electrically connected to the gate lines and the data lines; and
multiple pixels electrically connected to the multiple switching elements, respectively;
a data driver configured to output a data signal to the data lines; and
a gate driver configured to delay a gate signal and output the delayed gate signal to the gate lines.

9. The display device of claim 8, wherein the gate driver comprises an impedance element to delay the gate signal.

10. The display device of claim 9, wherein the impedance element is provided corresponding to one of the gate lines that is coupled to an output stage of the gate driver.

11. The display device of claim 9, wherein the impedance element has an impedance in a range from about twenty percent to about thirty percent of an impedance of the gate line coupled to the output stage.

12. The display device of claim 9, wherein the impedance element comprises a resistance element having a resistance of about two kiloohms.

13. The display device of claim 8, further comprising fan-outs to electrically connect the gate driver part and the gate lines, the fan-outs having substantially the same length.

14. A display device comprising:
a display panel including:
multiple gate lines;
multiple data lines;
multiple switching elements formed in regions surrounded by neighboring gate lines and neighboring data lines, the switching elements being electrically connected to the gate lines and the data lines; and
multiple pixels electrically connected to the multiple switching elements, respectively;
a data driver configured to output a data signal to the data lines;
a gate driver configured to forcedly delay a gate signal and having output stages configured to output the forcedly-delayed gate signal to the gate lines; and
multiple fan-outs electrically connecting the output stages of the gate driver to the gate lines, the fan-outs having substantially the same length.

15. A driving apparatus for driving an LCD device having a display panel including multiple gate lines, multiple data lines, multiple switching elements coupled to the gate lines and the data lines, and multiple pixels coupled to the multiple switching elements, respectively, the driving apparatus comprising:
a data driver configured to output a data signal to the data lines; and
a gate driver configured to delay a gate signal and output the delayed gate signal to the gate lines.

16. A driving method to drive an LCD panel including multiple gate lines, multiple data lines, multiple switching elements formed in regions surrounded by neighboring gate lines and neighboring data lines and connected to the gate lines and the data lines, and multiple liquid crystal capacitors electrically connected to the multiple switching elements, the method comprising:
providing a data signal to the multiple data lines; and
providing a delayed gate signal to the multiple gate lines in response to an externally provided carry signal in order to charge the data signal into the liquid crystal capacitors.

17. The method of claim 16, wherein the providing of the delayed gate signal comprises:
sequentially shifting a high level data by a time interval in response to the carry signal to sequentially output the shifted high level data;
level-shifting an externally provided first voltage based on the high level data so as to output the level-shifted first voltage;
buffering the level-shifted first voltage so as to output the buffered level-shifted first voltage; and
delaying the buffered level-shifted first voltage by a predetermined time to provide the delayed level-shifted first voltage to the gate line.
